(19) United States
(12) Patent Application Publication
(10) Pub. No.: US 2018/0159099 A1
(43) Pub. Date: Jun. 7, 2018

(54) BATTERY MODULE

(71) Applicant: J-TEK INCORPORATION, Hsinchu City (TW)

(72) Inventors: Ming-Da HSU, Hsinchu City (TW); Jui-Yi CHIEN, Hsinchu City (TW); Tzone-Yuan KUO, Hsinchu City (TW)

(21) Appl. No.: 15/887,627

(22) Filed: Feb. 2, 2018

Related U.S. Application Data
(63) Continuation-in-part of application No. 14/986,249, filed on Dec. 31, 2015.

(30) Foreign Application Priority Data
Dec. 31, 2014 (TW) 103146508

(51) Int. Cl. H01M 2/10; H01M 2/04; H01M 2/20; H01M 2/34

(52) U.S. Cl. CPC H01M 2/1077; H01M 2/105; H01M 2/34; H01M 2/202; H01M 2/04

(57) ABSTRACT

A battery module includes a top integrated battery core frame, a plurality of battery cores and a bottom integrated battery core frame. The top integrated battery core frame includes a top insulation frame and a plurality of top suspension plates, and each one of the top suspension plates includes a top supporting portion a top supporting portion, a top bent portion and a top suspension portion. The top supporting portion is fastened by the top insulation frame, the top bent portion is integrally connected with the top supporting portion and the top suspension portion, and the top supporting portion formed with at least one top welding protrusion welded a top battery code electrode of each one of the battery cores. The structure of the bottom integrated battery core frame is similar to the top integrated battery core frame so as to make the battery core be suspendedly welded therebetween.

This application is a CIP (Continuation In Part) application of the application Ser. No. 14/986,249; titling “BATTERY MODULE AND MANUFACTURING METHOD THEREOF”, filed on Dec. 31, 2015, which claims the benefit of Taiwan Patent Application Serial No. 103146508, filed on Dec. 31, 2014, the subject matter of which is incorporated herein by reference.

### BACKGROUND OF INVENTION

### 1. Field Of The Invention

The present invention is related to a battery module, and more particularly related to the battery module with battery core being suspendedly welded with a top integrated battery core frame and a bottom integrated battery core frame to make the battery module stably discharge power in a vibration condition.

### 2. Description Of The Prior Art

Because of the increasing price of fossil-based fuel and the rising awareness of environment protection, many alternative energy sources, such as bio-diesel, fuel cell, solar energy or wind energy, had been developed for vehicles. Among the various alternative fuel vehicles, electric car is still the main trend in present. The battery module for the electric car usually includes a plurality of battery cores, a cathode metal electrode plate, and an anode metal electrode plate to connect the battery cores in serial or parallel according to the need.

Following up, please refer to FIG. 1, which illustrates the structure of a battery module in a prior art. A battery module PA 1 provided in the prior art includes a top PCB PA 11 and a bottom PCB PA12 and a plurality of battery cores PA13. The top PCB PA 11 and the bottom PCB include a plurality of top contact pads PA 111 and bottom contact pads PA 121 respectively. Each of the top contact pads PA 111 is fixed with a top conductive coil spring PA 112, and each of the bottom contact pads PA 121 is fixed with a bottom conductive coil spring PA122. The top conductive coil spring PA 112 and the respective bottom conductive coil spring PA122 are depressed to restrain one of the battery cores PA 13 therebetween.

However, any person skilled in the art can easily know that when the battery module PA1 is assembled into a dynamic device, such as an electric car, the battery module PA1 have to work in a vibration condition. Please refer to FIG. 2, which illustrates a situation of the battery module of prior art working in a vibration condition. It can be known from FIG. 2 that when the battery module PA1 works in the vibration condition, the top conductive coil spring PA 112 and the bottom conductive coil spring PA122 is continuously and irregularly depressed to cause the battery cores PA 13 inclined as presented in FIG. 2 to cause the effective contact conditions between the top conductive coil spring PA 112, the battery core(s) PA13, and the bottom conductive coil spring PA122 are continuously and irregularly varied.

Nevertheless, the effective contact conditions between the conductive coil spring PA 112, the battery core(s) PA13 and the bottom conductive coil spring PA122 are also continuously and irregularly varied due to the reason that the lengths of the top conductive coil spring PA 112 and the bottom conductive coil spring PA122 are continuously and irregularly varied in the vibration condition, such as in the instant presented in FIG. 2 length of top conductive coil spring PA 112 become longer than the length of the bottom conductive coil spring PA122. The situation causes the contact resistance between the top contact PAD PA 111, battery core PA13 and the bottom contact PAD PA121 continuously and irregularly varied. Any person skilled in the art can easily know that when the contact resistance is continuously and irregularly varied, the current and of the power charged to and discharged from the battery module PA1 will become unstable.

In the prior art, in order to reduce the variation altitude of the contact resistance, it is necessary to use the top conductive coil spring PA 112 and the bottom conductive coil spring PA122 with larger elasticity coefficient, so as to provide greater elastic restoring force to reduce the vibration amplitude, so as to thinly secure the battery cores PA 13 therebetween. However, greater elastic restoring force will make the top and the bottom battery core electrode of the battery core PA13 suffer larger stress to cause permanent or fatigue damage occurred more easily.

### SUMMARY OF THE INVENTION

Since the battery module in prior art has the problem that when it works in the vibration condition, the effective contact conditions are continuously and irregularly varied to cause the power charged and discharged from the battery module become unstable, or the (top and bottom) battery core electrodes may be easily damaged when suffering larger stress caused by the conductive coil springs. An objective of the present invention is to provide a new battery module, in which the effect contact condition between the battery cores and the top and the bottom contact members (i.e., the top and the bottom electrode layers) substantially keeps in the same (only varied in little amplitude) during the period that the battery module works in a vibration condition, so as to make the power discharged from the battery module become more stable when the battery module works in a vibration condition. Another objective of the present invention is to provide the new battery module, in which the the (top and bottom) battery core electrodes no longer suffer larger stress caused by greater elastic restoring force with respect to prior art.

To fulfill the objective, a battery module is provided in the present invention. The battery module includes a top integrated battery core frame, a plurality of battery cores and a bottom integrated battery core frame. The top integrated battery core frame includes a top electrode layer and a top insulation frame. The top electrode layer includes a top electrode frame assembly and a plurality of top suspension plates. The top suspension plates are separated from each other, and are further separated from the top electrode frame assembly. Each top suspension plate includes a top supporting portion, a top bent portion and a top suspension portion. The top bent portion is integrally extended from the top supporting portion. The top suspension portion is integrally extended from the top bent portion, and downwardly formed with at least one top welding protrusion.

The top insulation frame covers the top electrode layer to fasten the top supporting portion of each top suspension plate. The top insulation frame is fanned with a plurality of top welding openings and top wire-bonding openings with respect to the top suspension plates. Each top welding opening is formed to make the top bent portion and the top suspension portion of a respective one of the top suspension plates exposed from the top insulation frame. Each top wire-bonding opening is formed to make the respective one of the top suspension plates partially exposed from the top insulation frame for bonding at least one top wire from the respective one of the top suspension plates to the top electrode frame assembly.

Each battery core includes a top battery code electrode and a bottom battery core electrode, and the top battery code electrode is welded with the top welding protrusion of the top suspension portion of the respective one of the top suspension plates, so as to forth at least one top weld contact zone between the top battery code electrode and the at least one top welding protrusion of the top suspension portion of the respective one of the top suspension plates.

The structure of the bottom integrated battery core frame is similar to the top integrated battery core frame. In detail, the bottom integrated battery core frame includes a bottom electrode layer and a bottom insulation frame. The bottom electrode layer includes a bottom electrode frame assembly and a plurality of bottom suspension plates. The bottom suspension plates are integrally extended from the bottom electrode frame assembly.

Each bottom suspension plate includes a bottom supporting portion, a bottom bent portion and a bottom suspension portion. The bottom bent portion is integrally extended from the bottom supporting portion. The bottom suspension portion is integrally extended from the bottom bent portion, and upwardly formed with at least one bottom welding protrusion. The at least one bottom welding protrusion is welded with the bottom battery core electrode, so as to form at least one bottom weld contact zone between the bottom battery code electrode and the at least one bottom welding protrusion of the bottom suspension portion of the respective one of the bottom suspension plates.

The bottom insulation frame covers the bottom electrode layer to fasten the bottom supporting portion of each bottom suspension plate. The bottom insulation frame is formed with a plurality of bottom welding openings with respect to the bottom suspension plates. Each bottom welding opening is formed to make the bottom bent portion and the bottom suspension portion of a respective one of the bottom suspension plates exposed from the bottom insulation frame.

Preferably, the top battery code electrode is welded with the top welding protrusion of the top suspension portion by spot-welding or laser welding. Similarly, the bottom battery code electrode is also welded with the bottom welding protrusion of the bottom suspension portion by spot-welding or laser-welding. Therefore, the at least one top weld contact zone and the at least one bottom weld contact zone can be a plurality of spot-welded contact zones or laser-welded contact zones.

In one preferred embodiment of the present invention, the battery cores are arranged in a first row and a second row. The battery cores are arranged in a first row and a second row, the first row of the battery cores are upright battery cores, the top battery core electrode of each the upright battery core is a positive top battery core electrode, and the bottom battery core electrode of each upright battery core is a negative bottom battery core electrode. The second row of the battery cores are inverted battery cores, the top battery core electrode of each inverted battery core is a negative top battery core electrode, and the bottom battery core electrode of each inverted battery core is a positive bottom battery core electrode.

In the preferred embodiment of the present invention, the top electrode frame assembly includes a positive top electrode frame and a negative top electrode frame, the positive top electrode frame is electrically connected to each top suspension plate welded with the positive top battery core electrode through wire bonding. The negative top electrode frame is separated from the positive electrode frame, and also electrically connected to each top suspension plate welded with the negative top battery core electrode through wire bonding.

Furthermore, in the preferred embodiment of the present invention, the top insulation frame is formed with a plurality of top positioning tubes with respect to the top welding openings and the battery cores, and the bottom insulation frame is formed with a plurality of bottom positioning tubes paired with the top positioning tubes. Each pair of the top positioning tube and the bottom positioning tube is applied to position and restrain the respective one of the battery cores therebetween. And an adhesive glue or epoxy is applied inside the top and the bottom positioning tubes to further secure the battery cores therebetween.

In the preferred embodiment, each of the top insulation frame and the bottom insulation frame is formed with at least one assembling protrusion and at least one assembling notch. Through assembling the at least one assembling protrusion of the battery module to the at least one assembling notch of another the same battery module, the battery module can be easily and firmly assembled to another one or more the same battery module(s) to from an integrated battery module. Nevertheless, in order to strengthen the structure of the battery module, in the preferred embodiment, the top insulation frame and the bottom insulation frame can be made of a plastic material with glass fiber therein.

It is clear that in the present invention, the top battery core electrode is welded to the top welding protrusion of the top suspension portion of the top suspension plate, and the bottom electrode core is welded to the bottom welding protrusion of the bottom suspension portion of the bottom suspension plate. Namely, because the battery cores are suspendedly welded between the top integrated battery core frame and the bottom integrated battery core frame, the effective contact conditions (i.e. the plane areas of top weld contact zone and the at least one bottom weld contact zone) can always keep in substantially the same before or during the period of working in the vibration condition.

It is undoubted that by using aforesaid technology, when the battery module or the integrated battery module is assembled to any dynamic device, such as an electric car, to work in the vibration condition, the effective contact resistance will also be substantially kept stable before or during the period of the vibration condition, so as to ensure the battery module or the integrated battery module can stably store and discharge power.

Nevertheless, in the present invention, the (top and bottom) battery core electrodes of the battery cores are structurally and electrically connected to the (top and bottom) electrode layers of the (top and the bottom) integrated battery core frame by welding means, the (top and bottom) battery core electrodes will no longer suffer greater stress with respect to prior art, so as to further prevent the (top and bottom) battery core electrodes from fatigue or permanent damage.

### BRIEF DESCRIPTION OF THE DRAWINGS

The present invention will now be specified with reference to its preferred embodiment illustrated in the drawings, in which:

FIG. 1 illustrates the structure of a battery module in a prior art;

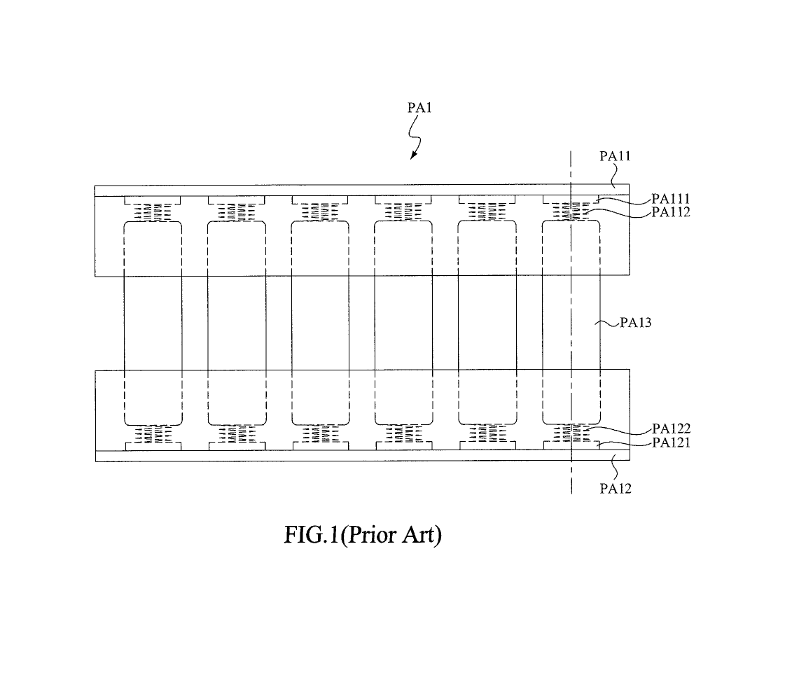

FIG. 2 illustrates a situation of the battery module of prior art working in a vibration condition;

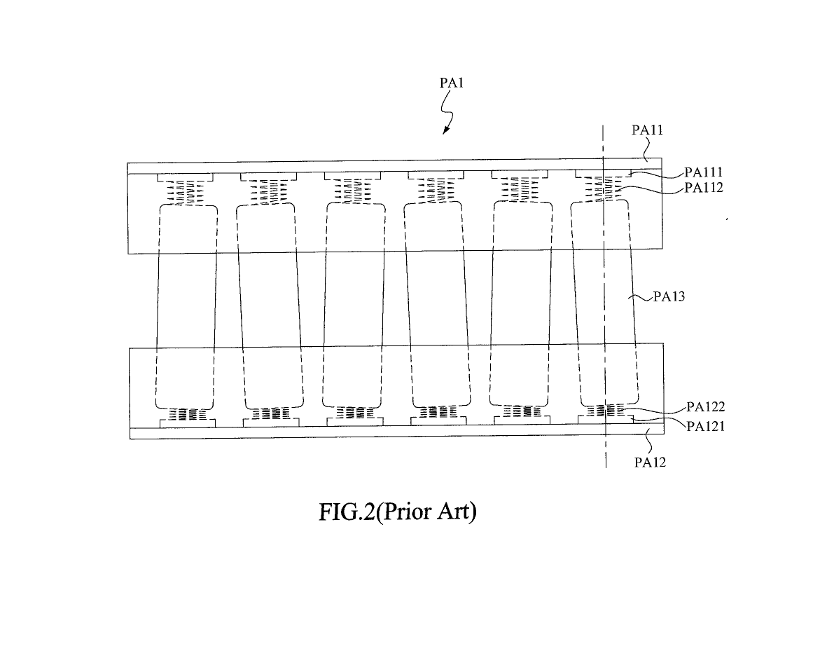

FIG. 3 illustrates a perspective view of an integrated battery module;

FIG. 4 illustrates a perspective view of the integrated battery module with one battery module thereof being removed in accordance with a preferred embodiment of the present invention;

FIG. 5 illustrates a perspective view of the (removed) battery module of FIG. 3;

FIG. 6 illustrate a perspective view of the battery module after hiding a top insulation frame and a bottom insulation frame thereof;

FIG. 7 illustrate another perspective view of the battery module after hiding the top insulation frame and the bottom insulation frame thereof;

FIG. 8 illustrates a top view of the battery module in accordance with the preferred embodiment of the present invention;

FIG. 9 illustrates a cross-sectional view of the battery module along the A-A cross section of FIG. 8 to illustrate the relation between the top integrated battery core frame, the upright battery core and the bottom integrated battery core frame;

FIG. 10 illustrates another cross-sectional view of the battery module along the B-B cross section of FIG. 8 to illustrate the relation between the top integrated battery core frame, the inverted battery core and the bottom integrated battery core frame;

FIG. 11 is an partially magnified view within the region C of FIG. 9 to illustrate the effective contact condition between the top suspension plate and the top battery core electrode before the battery module works in a vibration condition;

FIG. 12 illustrates the effective contact condition between the top suspension plate and the top battery core electrode when the battery module works in an instant of the vibration condition; and

FIG. 13 illustrates the effective contact condition between the bottom suspension plate and the bottom battery core electrode when the battery module works in the instant of the vibration condition

### DESCRIPTION OF THE PREFERRED EMBODIMENT

There are various embodiments of the battery module and the manufacturing method thereof provided in the present invention, which are not repeated hereby. A preferred embodiment is mentioned in the following paragraphs as an example.

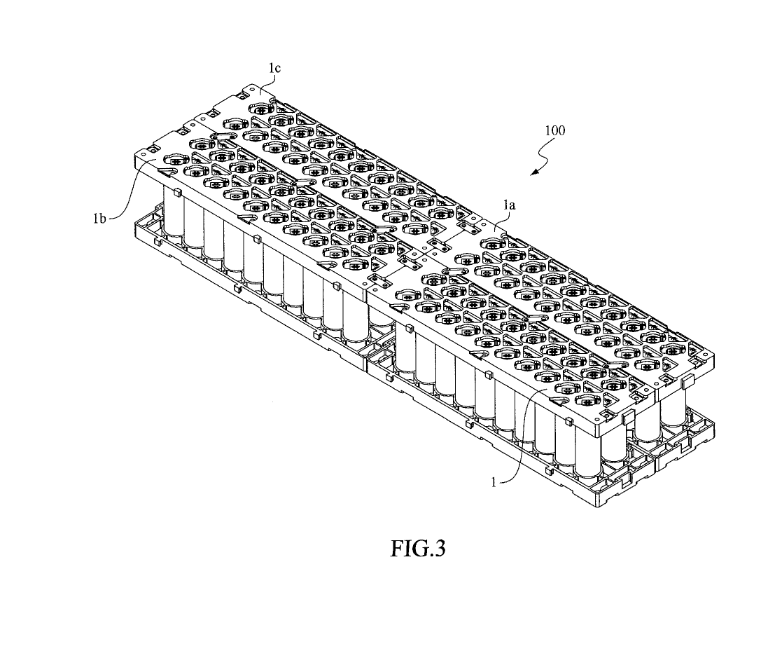

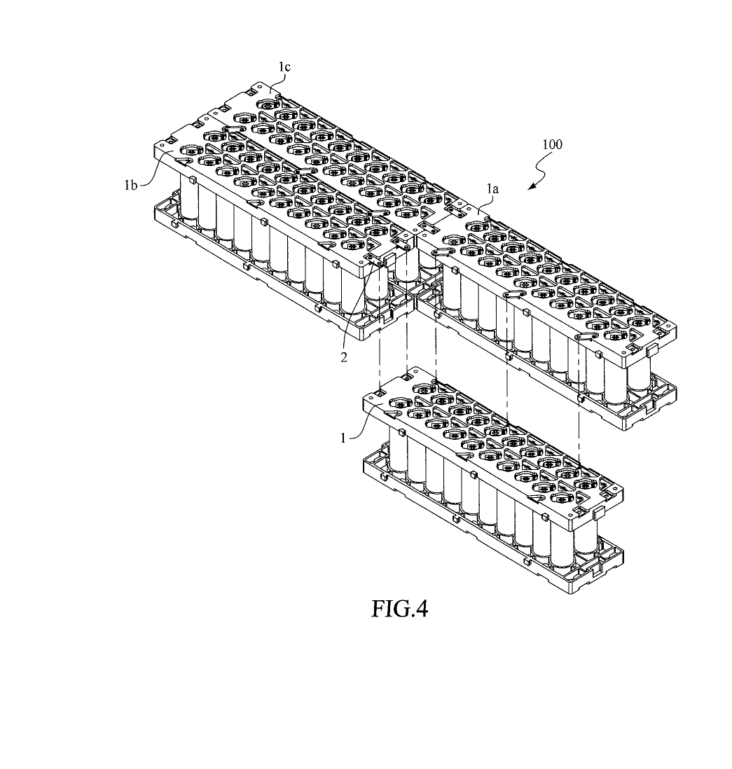

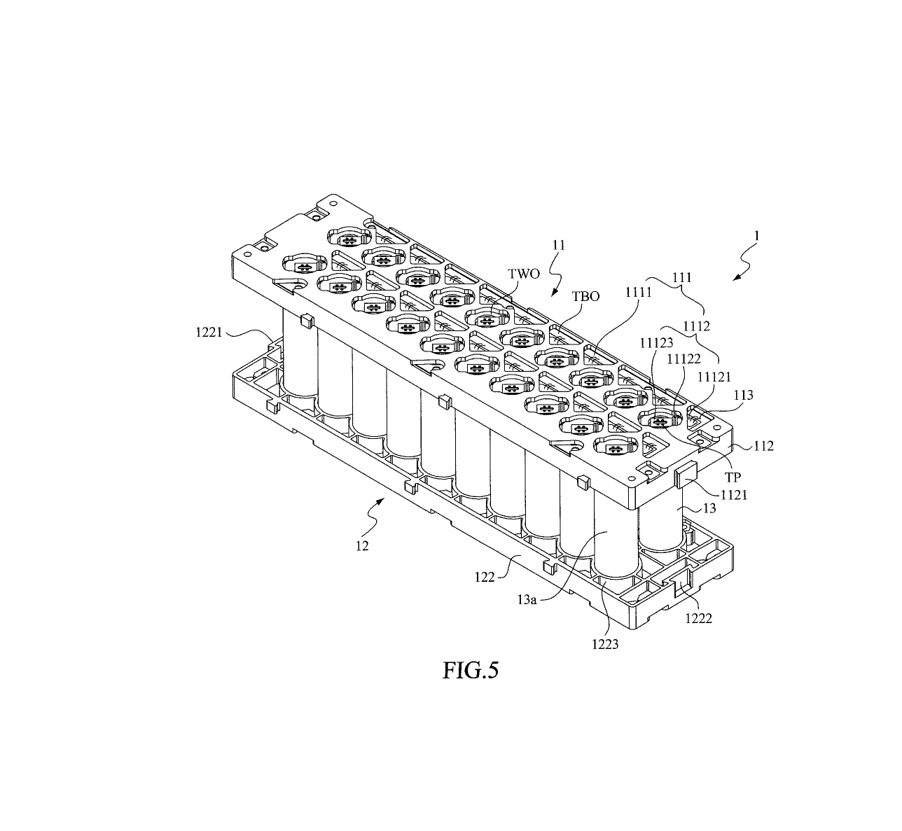

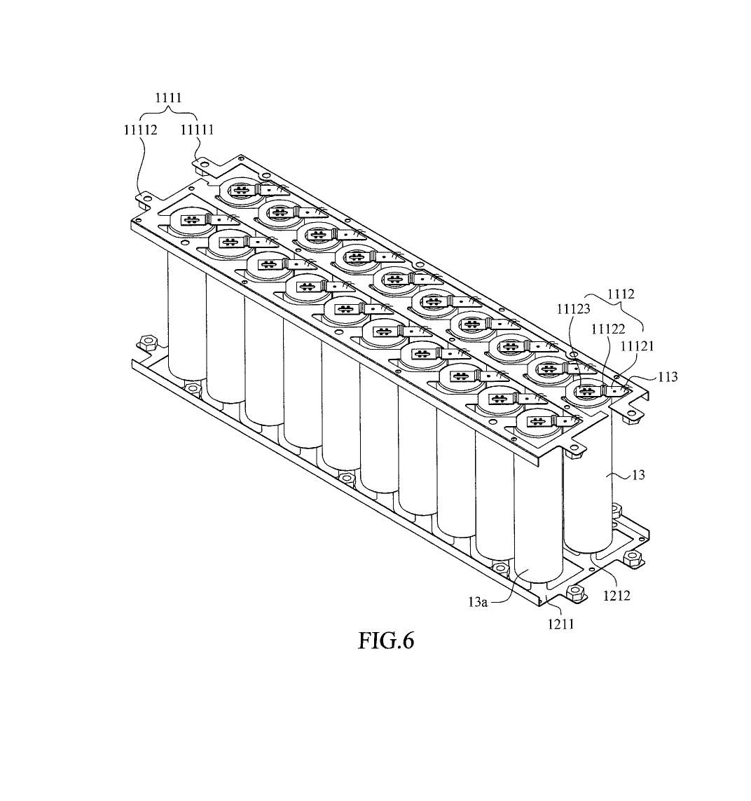

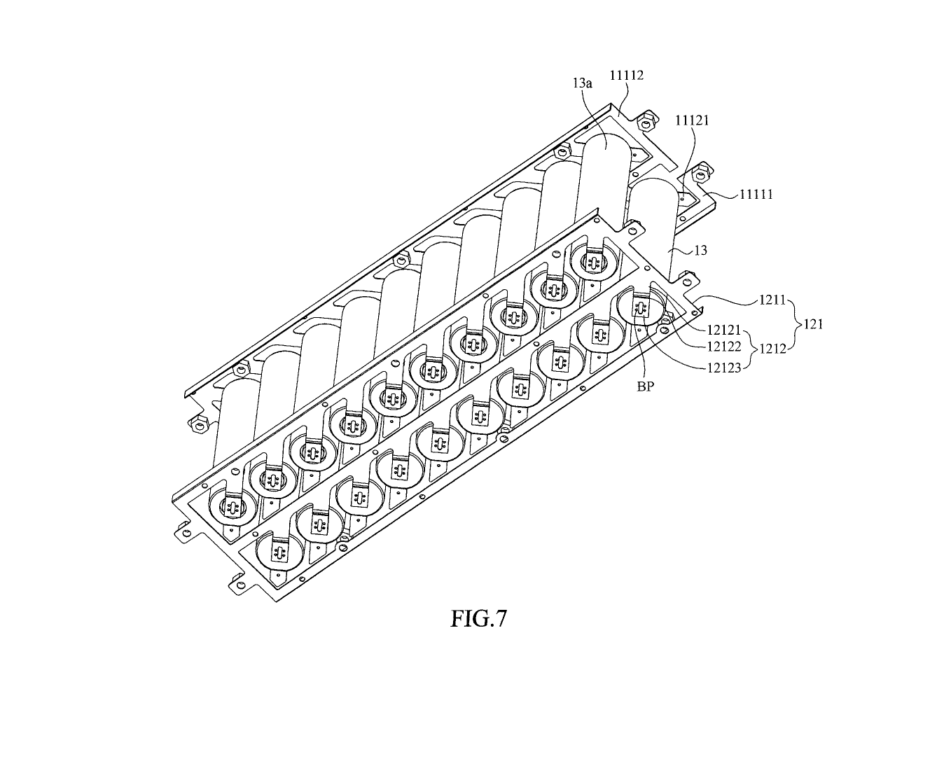

Please refer to FIGS. 3 to 7, in which FIG. 3 illustrates a perspective view of an integrated battery module; FIG. 4 illustrates a perspective view of the integrated battery module with one battery module thereof being removed in accordance with a preferred embodiment of the present invention; FIG. 5 illustrates a perspective view of the (removed) battery module of FIG. 3; FIG. 6 illustrate a perspective view of the battery module after hiding a top insulation frame and a bottom insulation frame thereof; and FIG. 7 illustrate another perspective view of the battery module after hiding the top insulation frame and the bottom insulation frame thereof. As presented in FIGS. 3 to 7, a battery module 1 can be assembled to another three the same battery modules 1a, 1b and 1c to form an integrated battery module 100. In the integrated battery module 100, a plurality of conductive connection pieces 2 are applied to electrically connected to any two neighboring battery modules, such as the battery module 1 and the battery module 1b.

The battery module 1 includes a top integrated battery core frame 11, a plurality of battery cores and a bottom integrated battery core frame 12. The top integrated battery core frame 11 includes a top electrode frame assembly 111 and a top insulation frame 112. The top electrode layer 111 includes a top electrode frame assembly 1111 and a plurality of top suspension plates 1112.

The top electrode frame assembly 1111 includes a positive top electrode frame 11111 and a negative top electrode frame 11112, and the negative top electrode frame 11112 is separated from the positive electrode frame 11111. The top suspension plates 1112 are separated from each other, and are further separated from the top electrode frame assembly 1111. Each top suspension plate 1112 includes a top supporting portion 11121, a top bent portion 11122 and a top suspension portion 11123. The top bent portion 11122 is integrally extended from the top supporting portion 11121. The top suspension portion 11123 is integrally extended from the top bent portion 11122, and downwardly formed with at least one top welding protrusion TP.

Preferably, the top insulation frame 112 can be formed by insert-molding method, so as to make the top electrode layer 111 be embedded therein. Therefore, the top insulation frame 112 covers around the top electrode layer 111 to fasten the top supporting portion 11121 of each top suspension plate 1112. The top insulation frame 112 is further formed with a plurality of top welding openings TWO and top wire-bonding openings TBO with respect to the top suspension plates 1112. Each top welding opening TWO is formed to make the top bent portion 11122 and the top suspension portion 11123 of a respective one of the top suspension plates 1112 exposed from the top insulation frame 112. Each top wire-bonding opening TBO is formed to make the top supporting portion 1121 of the respective one of the top suspension plates 112 partially exposed from the top insulation frame for bonding at least one top wire 113 from the top supporting portion 11123 to the top electrode frame assembly 1111.

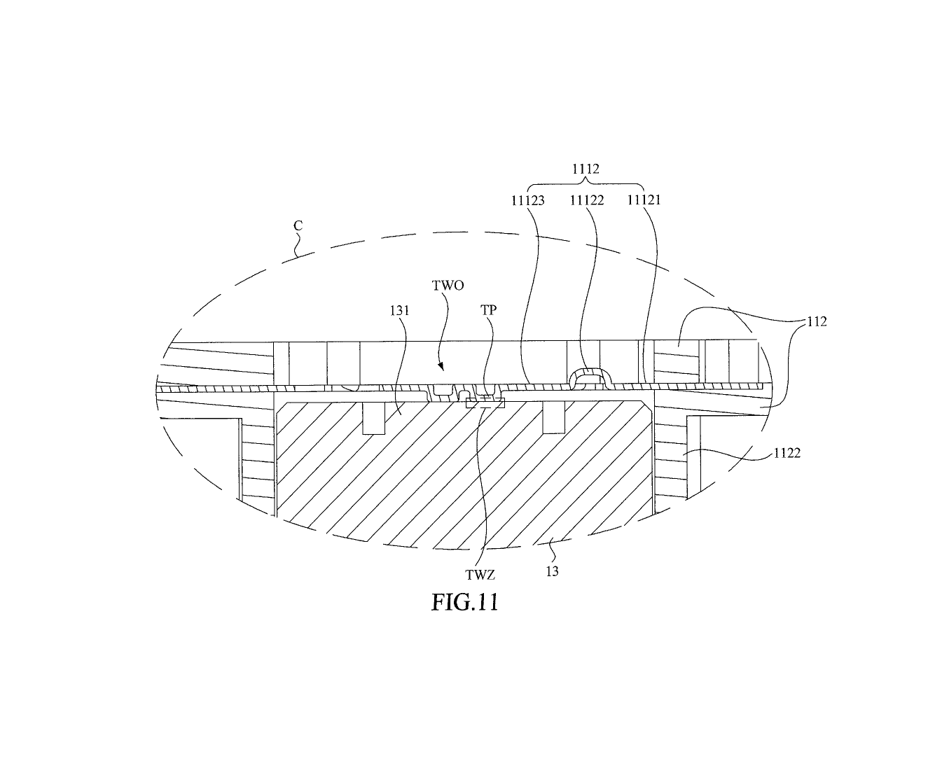

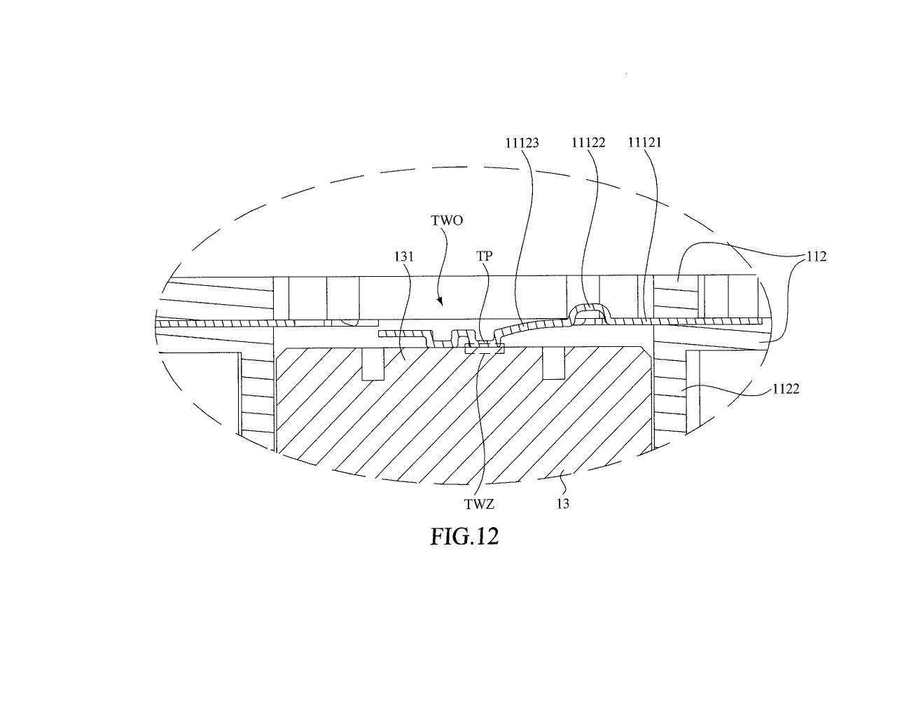

Each battery core includes a top battery code electrode and a bottom battery core electrode, and the top battery code electrode is welded with the top welding protrusion TP of the top suspension portion 11123 of the respective one of the top suspension plates 1112, so as to farm at least one top weld contact zone TWZ (see FIG. 11 or FIG. 12) between the top battery code electrode and the at least one top welding protrusion TP of the top suspension portion 11123 of the respective one of the top suspension plates 1112.

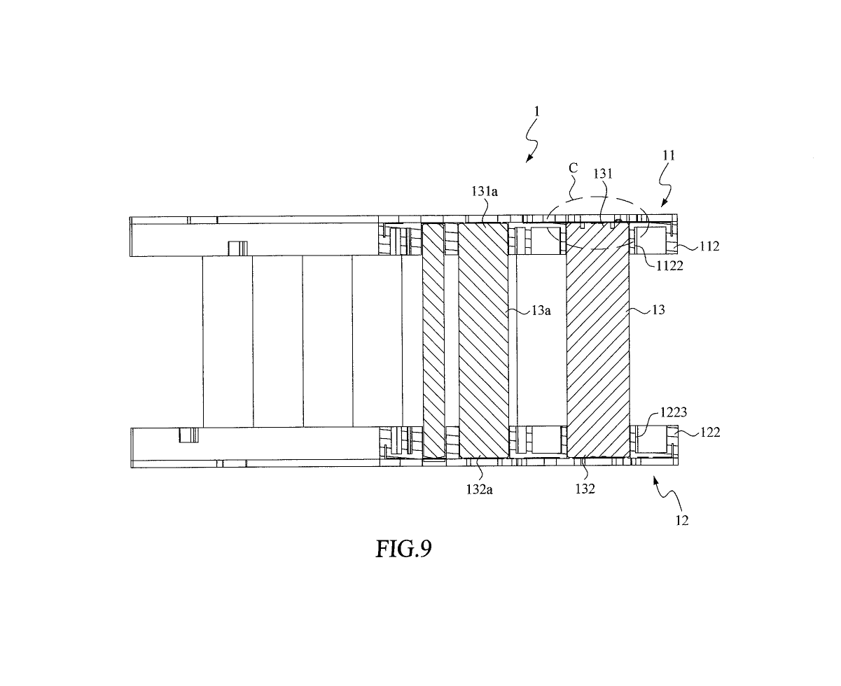

In the preferred embodiment, the battery cores are arranged in two rows, i.e., a first row and a second row. The first row of battery cores are upright battery cores 13, each upright battery core 13 has a top battery core electrode and a bottom battery core electrode, the top battery core electrode of each upright battery core 13 is a positive top battery core electrode 131 (see FIG. 9), and the bottom battery core electrode of each upright battery core 13 is a negative bottom battery core electrode 132 (see FIG. 9). The second row of battery cores are inverted battery cores 13a, each inverted battery core 13a has a top battery core electrode and a bottom battery core electrode, the top battery core electrode of each inverted battery core 13a is a negative top battery core electrode 131a (see FIG. 9), and the bottom battery core electrode of each inverted battery core 13a is a positive bottom battery core electrode 132a (see FIG. 9).

Aforesaid positive top electrode frame 11111 is electrically connected to each top suspension plate 1112 welded with the positive top battery core electrode 131 through bonding the top wire 113 therebetween. The negative top electrode frame 11112 is also electrically connected to each top suspension plate 1112 welded with the negative top battery core electrode 131a through bonding another top wire 113 therebetween.

The structure of the bottom integrated battery core frame 12 is similar to the top integrated battery core frame 11. In detail, the bottom integrated battery core frame 12 includes a bottom electrode layer 121 and a bottom insulation frame 122. The bottom electrode layer 121 includes a bottom electrode frame assembly 1211 and a plurality of bottom suspension plates 1212. The bottom suspension plates 1212 are integrally extended from the bottom electrode frame assembly 1211.

Each bottom suspension plate 1212 includes a bottom supporting portion 12121, a bottom bent portion 12122 and a bottom suspension portion 12123. The bottom bent portion 12122 is integrally extended from the bottom supporting portion 12121. The bottom suspension portion 12123 is integrally extended from the bottom bent portion 12122, and upwardly formed with at least one bottom welding protrusion BP. The at least one bottom welding protrusion BP is welded with the bottom battery core electrode (the negative bottom battery core electrode 132 of each upright battery core 13 or the positive bottom battery core electrode 132a or the inverted battery core 13a ), so as to form at least one bottom weld contact zone BWZ between the bottom battery code electrode and the at least one bottom welding protrusion BP of the bottom suspension portion 12123 of the respective one of the bottom suspension plates 1212.

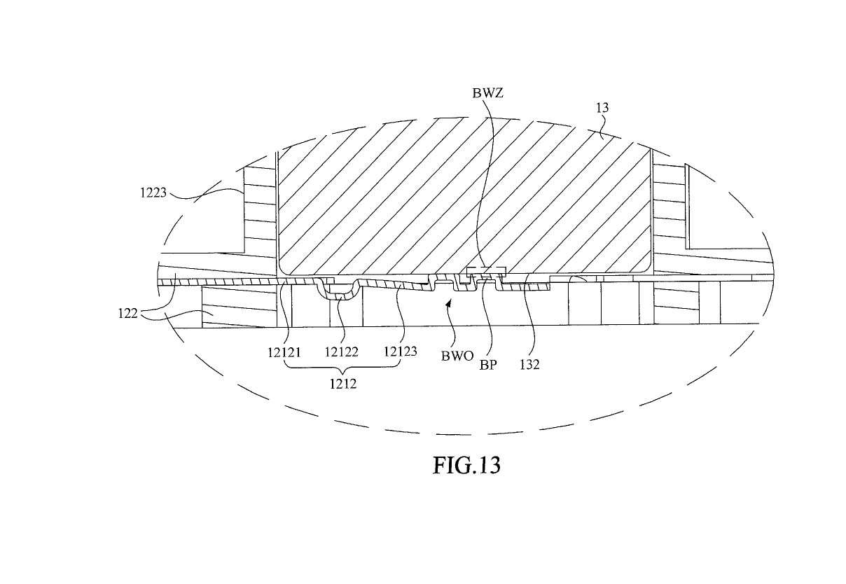

Similarly, the bottom insulation frame 122 also can be formed by insert-molding method, so as to make the bottom electrode layer 121 be embedded therein. Therefore, the bottom insulation frame 122 covers around the bottom electrode layer 121 to fasten the bottom supporting portion 12123 of each bottom suspension plate 1212. The bottom insulation frame 122 is formed with a plurality of bottom welding openings BWO (see FIG. 13) with respect to the bottom suspension plates 1212. Each bottom welding opening is formed to make the bottom bent portion 12122 and the bottom suspension portion 12123 of a respective one of the top suspension plates 1212 exposed from the bottom insulation frame 122.

Preferably, the top battery code electrode (i.e. any one of the positive top battery core electrode 131 or the negative top battery core electrode 131a) can be welded with the top welding protrusion TP of the top suspension portion 11123 by spot-welding or laser welding, and similarly, the bottom battery code electrode (i.e. any one of the negative bottom battery core electrode 132 or the positive bottom battery core electrode 132a ) is also welded with the bottom welding protrusion BP of the bottom suspension portion 12123 by spot-welding or laser-welding. Therefore, the at least one top weld contact zone TWZ and the at least one bottom weld contact zone BWZ can be a plurality of spot-welded contact zones or laser-welded contact zones. Through adjusting to energy of spot-welding or laser-welding or adjusting the forming amount of top weld contact zone TWZ and the bottom weld contact zone BWZ (choosing the amount of the top welding protrusion TP and the bottom welding protrusion BP to be welded), the area of the top weld contact zone TWZ and the bottom weld contact zone BWZ can be adjusted, so as to further adjust the contact resistance between the top electrode layer 111 the battery cores (including the upright battery cores 13 an the inverted battery cores 13a) and the bottom electrode layer 121.

Furthermore, the top insulation frame 112 is further formed with at least one assembling protrusion 1121 and at least one assembling notch (not presented in drawings). Similarly, the bottom insulation frame 122 is formed with at least one assembling protrusion 1221 and at least one assembling notch 1222. Through assembling the assembling protrusion 1221 of the battery module 1 to the assembling notch of another the same battery module 1b, the battery module 1 can be easily and firmly assembled to another one or more the same battery module(s) 1b (all of the battery modules 1a, 1b and 1c) to from an integrated battery module 100. Moreover, in order to strengthen the structure of the battery module 1, in the preferred embodiment, each of the top insulation frame and the bottom insulation frame can be made of a plastic material with glass fiber therein.

The top insulation frame 112 is formed with a plurality of top positioning tubes 1122 (see FIG. 9) with respect to the battery cores, and the bottom insulation frame 122 is formed with a plurality of bottom positioning tubes 1223 paired with the top positioning tubes 1122. Each pair of the top positioning tube 1122 and the bottom positioning tube 1223 is applied to position and restrain the respective one of the battery cores (each of the upright battery cores 13 and the inverted battery cores 13a ) therebetween. And an adhesive glue or epoxy is applied inside the top positioning tubes 1122 and the bottom positioning tube 1223 to further secure the battery cores (each of the upright battery cores 13 and the inverted battery cores 13a ) therebetween.

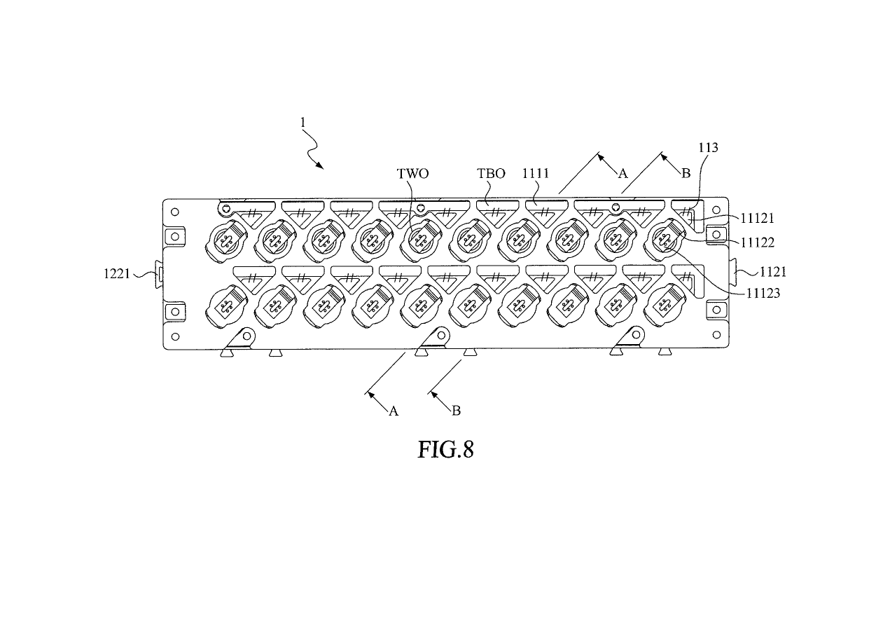

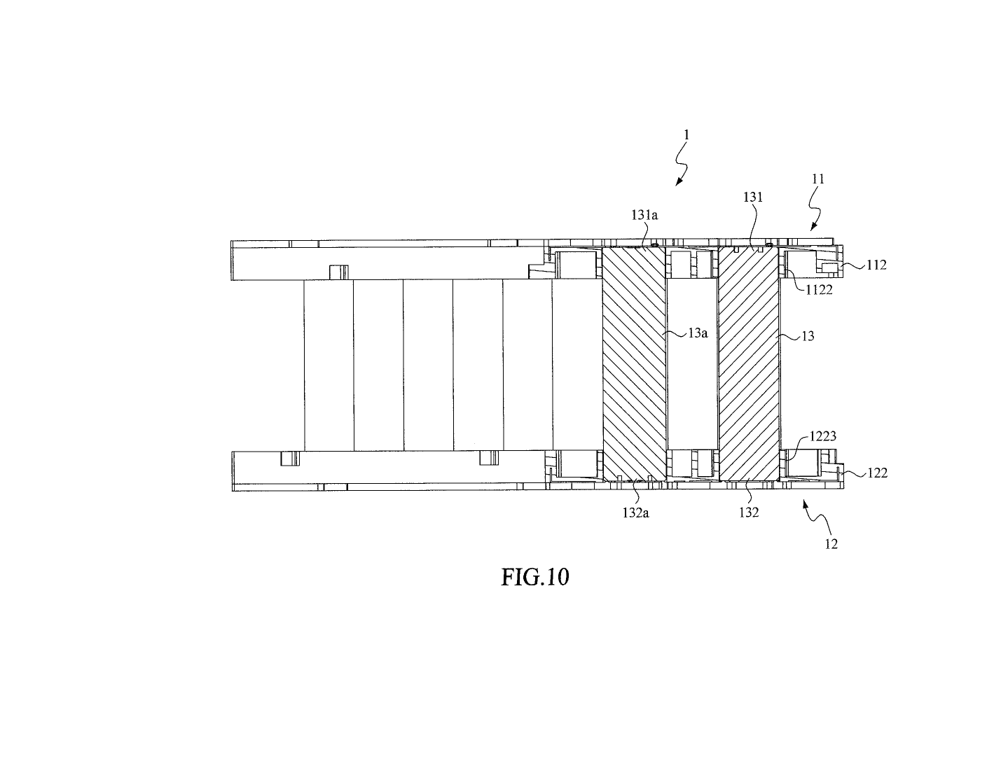

Please further refer to FIGS. 8 to 13, in which FIG. 8 illustrates a top view of the battery module in accordance with the preferred embodiment of the present invention; FIG. 9 illustrates a cross-sectional view of the battery module along the A-A cross section of FIG. 8 to illustrate the relation between the top integrated battery core frame, the upright battery core and the bottom integrated battery core frame; FIG. 10 illustrates another cross-sectional view of the battery module along the B-B cross section of FIG. 8 to illustrate the relation between the top integrated battery core frame, the inverted battery core and the bottom integrated battery core frame; FIG. 11 is an partially magnified view within the region C of FIG. 9 to illustrate the effective contact condition between the top suspension plate and the top battery core electrode before the battery module works in a vibration condition; FIG. 12 illustrates the effective contact condition between the top suspension plate and the top battery core electrode when the battery module works in an instant of the vibration condition; and FIG. 13 illustrates the effective contact condition between the bottom suspension plate and the bottom battery core electrode when the battery module works in the instant of the vibration condition.

As presented in FIGS. 9 and 11, before the battery module 1 works in the vibration condition, the top suspension portion 11123 of the top suspension plate 1112 is substantially parallel to the top support portion 11121 of the top suspension plate 1112 (may somehow bent due to suffering weight of the upright battery core 13), the effective contact area between the positive top battery core electrode 131 and the top suspension plate 1112 substantially equals to the plane area of the top weld contact zone TWZ. Comparing with FIG. 12 with FIG. 11, when the battery module works in an instant of the vibration condition, the top suspension portion 11123 is obviously downwardly bent, but the effective contact area between the positive top battery core electrode 131 and the top suspension plate 1112 still keeps in substantially equaling to the plane area of the top weld contact zone TWZ.

Please further refer to FIG. 13, at the same instant, the bottom suspension portion 12123 is also synchronously downwardly bent, but the effective contact area between the negative bottom battery core electrode 132 and the bottom suspension plate 1212 still keeps in substantially equaling to the plane area of the bottom weld contact zone BWZ. Moreover, the overall (downwardly bent) deformation of the bottom suspension plate 1212 is substantially equal to (or very close to) the overall (downwardly bent) deformation of the top bottom suspension plate 1112 during the period of working in the vibration condition.

After reading above description, it is clear that in the present invention, the top battery core electrode is welded to the top welding protrusion TP of the top suspension portion 11123 of the top suspension plate 1112, and the bottom electrode core is welded to the bottom welding protrusion BP of the bottom suspension portion 12123 of the bottom suspension plate 1112. Namely, because the battery cores (the upright battery cores 13 and the inverted battery cores 13a ) are suspendedly welded between the top integrated battery core frame 11 and the bottom integrated battery core frame 11, aforesaid effective contact condition can always keep in substantially sable before or during the period of working in the vibration condition.

It is undoubted that when the battery module 1 or the integrated battery module 100 is assembled to any dynamic device, such as an electric car, to work in the vibration condition, the effective contact resistance will also be substantially kept stable before or during the period of the vibration condition, so as to ensure the battery module 1 or the integrated battery module 100 can stably store and discharge power.

Nevertheless, in the present invention, the top and the bottom battery core electrodes of the battery cores are structurally and electrically connected to the top and bottom electrode layers 111 and 112 of the top and the bottom integrated battery core frame 11 and 12 by welding means, the top and bottom battery core electrodes will no longer suffer greater stress with respect to prior art, so as to further prevent the top and bottom battery core electrodes from fatigue or permanent damage.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A battery module, comprising:
a top integrated battery core frame, including:
a top electrode layer, including:
a top electrode frame assembly; and
a plurality of top suspension plates, separated from each other, further separated from the top electrode frame assembly, and each of the top suspension plates including:
a top supporting portion;
a top bent portion, integrally extended from the top supporting portion; and
a top suspension portion, integrally extended from the top bent portion, and downwardly formed with at least one top welding protrusion; and
a top insulation frame, covering the top electrode layer to fasten the top supporting portion of each of the top suspension plates, and further formed with a plurality of top welding openings and top wire-bonding openings with respect to the top suspension plates, each of the top welding openings being formed to make the top bent portion and the top suspension portion of a respective one of the top suspension plates exposed from the top insulation frame, and each of the top wire-bonding openings being formed to make the respective one of the top suspension plates partially exposed from the top insulation frame for bonding at least one top wire from the respective one of the top suspension plates to the top electrode frame assembly;
a plurality of battery cores, each of the battery cores including a top battery code electrode and a bottom battery core electrode, and the top battery code electrode being welded with the at least one top welding protrusion of the top suspension portion of the respective one of the top suspension plates, so as to form at least one top weld contact zone therebetween; and
a bottom integrated battery core frame, including:
a bottom electrode layer, including:
a bottom electrode frame assembly; and
a plurality of bottom suspension plates integrally extended from the bottom electrode frame assembly, and each of the bottom suspension plates including:
a bottom supporting portion;
a bottom bent portion, integrally extended from the bottom supporting portion; and
a bottom suspension portion, integrally extended from the bottom bent portion, and upwardly formed with at least one bottom welding protrusion being welded with the bottom battery core electrode, so as to form at least one bottom weld contact zone therebetween; and
a bottom insulation frame, covering the bottom electrode layer to fasten the bottom supporting portion of each of the bottom suspension plates, and further formed with a plurality of bottom welding openings with respect to the bottom suspension plates, and each of the bottom welding openings being formed to make the bottom bent portion and the bottom suspension portion of a respective one of the bottom suspension plates exposed from the bottom insulation frame.

2. The battery module of claim 1, wherein the battery cores are arranged in a first row and a second row, the first row of the battery cores are upright battery cores, the top battery core electrode of each one of the upright battery cores is a positive top battery core electrode, and the bottom battery core electrode of each one of the upright battery cores is a negative bottom battery core electrode.

3. The battery module of claim 2, wherein the second row of the battery cores are inverted battery cores, the top battery core electrode of each one of the inverted battery cores is a negative top battery core electrode, and the bottom battery core electrode of each one of the inverted battery cores is a positive bottom battery core electrode.

4. The battery module of claim 3, wherein the top electrode frame assembly includes:
a positive top electrode frame, electrically connected to each one of the top suspension plates welded with the positive top battery core electrode through wire bonding;
a negative top electrode frame, separated from the positive electrode frame, and electrically connected to each one of the top suspension plates welded with the negative top battery core electrode through wire bonding.

5. The battery module of claim 1, wherein the top insulation frame is formed with a plurality of top positioning tubes with respect to the top welding openings and the battery cores, and the bottom insulation frame is formed with a plurality of bottom positioning tubes paired with the top positioning tubes, and each pair of one of the top positioning tubes and a respective one of the bottom positioning tubes are applied to position and restrain the respective one of the battery cores therebetween.

6. The battery module of claim 1, wherein the at least one top weld contact zone and the at least one bottom weld contact zone are a plurality of spot-welded contact zones.

7. The battery module of claim 1, wherein the at least one top weld contact zone and the at least one bottom weld contact zone are a plurality of laser-welded contact zones.

8. The battery module of claim 1, wherein each of the top insulation frame and the bottom insulation frame is formed with at least one assembling protrusion and at least one assembling notch for assembling another one of the battery module.

9. The battery module of claim 1, wherein the top insulation frame and the bottom insulation frame are made of a plastic material with glass fiber therein.

10. The battery module of claim 1, wherein each of the top wire-bonding openings being formed to further make the supporting portion of the respective one of the top suspension plates partially exposed from the top insulation frame.
